(19) United States
(12) Patent Application Publication
(10) Pub. No.: US 2008/0191174 A1
(43) Pub. Date: Aug. 14, 2008

(54) Use Of Heat-Activated Adhesive For Manufacture And A Device So Manufactured

(75) Inventors: Jakob Ehrensvard, Taby (SE); Leif Henrik Eriksson, Alvsjo (SE); Vilhelm Lindman, Stockholm (SE)

Correspondence Address: CONNOLLY BOVE LODGE & HUTZ LLP, 1875 EYE STREET, N.W., SUITE 1100, WASHINGTON, DC, 20036, US

(73) Assignee: Cypak AB, Stockholm (SE)

(21) Appl. No.: 11/994,939

(22) PCT Filed: Jun. 22, 2006
(86) PCT No.: PCT/EP2006/063467

§ 371 Date: Jan. 7, 2008

Related U.S. Application Data
(60) Provisional application No. 60/697,370, filed on Jul. 8, 2005.

(51) Int. Cl. C09J 9/02

(52) U.S. Cl. 252/500

(57) ABSTRACT

The invention is based on use of a heat-activated adhesive for manufacturing of intelligent devices comprising printed conductive electronics on a flexible substrate, where the adhesive is an anisotropic electrically conductive adhesive and is applied to the substrate as a thin film which can be used for electrical connections and for providing mechanical stability to the printed conductive electronics.

### TECHNICAL FIELD

The invention relates to use of heat-activated adhesive for manufacturing of intelligent devices comprising a flexible substrate with electronic components and conductive traces. The devices can be in the form of a card or a keypad or a package having one or more creasing.

### BACKGROUND OF THE INVENTION

Intelligent packaging or intelligent devices has a broad definition, ranging from RFID tags mounted on paper to using PSA-tape to complex assemblies of electronic modules connected to printed conductive traces and antennas via electronic interconnections.

Critical issues for producing intelligent disposable devices such as packages and disposable questionnaires are the attachment of the electronic module and the stability of the printed electronic devices like conductive traces, antennas etc on the package material. The attachment of the electronic module is normally done using an anisotropic conductive tape, z-tape, which provides adhesion and electric interconnection between conductive traces on the packaging material and the electronic module. The printed conductive traces are stabilized by placing a supportive tape over the critical areas, such as the creasing lines. The present method of handling manufacturing of intelligent devices involve to a large extent manual handling of several steps and a broad variety of materials which are difficult to incorporate into large-scale automated manufacturing.

Intelligent disposable devices on flexible substrates, such as paperboard or other cellulose material, plastics and with printed conductive traces, antenna or other devices interconnected to an electronic module, PCB or the like. The electronic components can be mounted on FR4, plastics, Kapton, polyester, metals or the like.

The z-tapes are associated with a high degree of sensitivity originating from the structure of the tape. Since the z-tapes are PSAs, they are sensitive to impurities in the environment like dust, which easily stick to the surfaces once the protective liners are removed. They are difficult to handle in an automated process because of the removal of the release liner before attachment to a substrate. The conductive agents in the z-tapes are usually metal particles with a highly defined diameter, making the tapes expensive and the sensitivity to the roughness of the substrate surface high.

There is a need for stabilizing printed conductive traces on flexible substrates. After printing the conductive devices are physically bonded to the surface of the substrate and are thus dependent on the properties of the substrate surface. Paperboard is a flexible material, but if wrinkles and creased or bent many times, the surface is likely to be damaged. If a surface is damaged, the overlying print will be damaged as well. The cracks at the surface are often seen as microscopic cracks in the printed conductive devices. This is a serious threat to devices made of flexible materials with printed conductive traces or other devices on. The problem with cracks has so far been solved by placing supportive tape over sensitive areas. This leads to several problems. One is the difficulty of handling tapes in an extra step in the production. Another is that cracks are expected to appear in creasing, but also other areas could be susceptible and it would be a mayor effort that would imply several application steps to put supportive tape over the whole surface of a packaging.

Today assembly and mounting of electronic components are normally made through soldering. This, however, involves many chemicals and materials that are dangerous and harm the environment. Also, soldering is disadvantageous in flexible applications, since the soldering joint is stiff. The normal procedure, when mounting a battery to a PCB, is to attach a clip with soldering to the PCB and then attach the battery to the clip. The same holds for other similar devices (soldering) such as buzzers. Today it is possible to use flexible materials (such as Kapton, which withstands the high temperatures reached during soldering), as a replacement to the PCB (FR4). This is an expensive material making it hard to justify for use in the low-cost applications of disposable packages. Other materials, such as polyesters, are not that resistant to heat, making it difficult or impossible to solder components to them.

### DESCRIPTION OF THE INVENTION

The objective of the present invention is to replace the use of existing diversity of adhesives (laminating adhesive, z-tape, protective tapes etc) that is currently applied in many steps during the manufacturing of an intelligent device comprising an electronic module and printed conductive traces on a flexible substrate, with one adhesive that is applied only once in the production. This adhesive has the following properties:

It is anisotropic electrically conductive, re-activable, elastic and printable.

Another objective is to use a production means that enables manufacturing of new designs of intelligent devices.

Another objective is to use a production means that enables manufacturing of intelligent devices including attached additional components.

Another objective is to have an intelligent device comprising an electronic module and printed conductive traces on a flexible substrate, which device has an increased resistance to cracking and degradation of printed electronic devices.

Another objective is to have new designs of intelligent devices which enable more freedom in designing printed electronic devices, quality control of sensitive areas and tamper detection.

Another objective is to have an intelligent device which can include attached components.

The above objectives can be realized by use of a heat-activated adhesive for manufacturing of intelligent devices comprising an electronic module and conductive traces on a flexible substrate, whereby the adhesive is an anisotropic adhesive and is applied to the substrate as a thin film which can be used as mechanical bonding of two paperboard sheets when converting to packages, electrically connecting conductive traces to an electronic module and for providing mechanical stability to the conductive traces.

The heat-activated adhesive comprises an adhesive component and a conductive part and the adhesive shall be possible to reactivate. The adhesive component can comprise a solvent- or water based thermoplastic and the conductive part can be a homogeneously distributed Intrinsically Conductive Polymers (ICPs), carbon black or metal or metal-coated particles or other conductive particles like carbon nanotubes, C60 etc.

By using the heat-activated adhesive for electrical connections of electronic components of the intelligent device as well as for stabilizing printed electronic devices on the flexible surface, the manufacturing of such devices is much simplified and the freedom of design of such devices increased.

In the process of connecting the electronic components, the heat-activated adhesive is also used for attaching an electronic module, batteries or other components which are not printed to the flexible surface.

The heat-activated adhesive can also be used for adding a second flexible substrate to the device. The second substrate can comprise printed electronic devices which can be electrically connected to electronic devices on the first flexible substrate, thereby enabling new designs of intelligent devices.

The heat-activated adhesive can be applied to the flexible surface by conventional printing techniques. The resulting surface is non-wetting before the heat activation step is performed. Heat activation is performed at moderate temperatures in order not to destroy the flexible substrate of the device. Temperatures in the interval of 60-150 C (80-130 C) are normally suitable. Conventional drying procedures after heat treatment which allows the substrate to dry without deforming the material can be used. The adhesive film can be reactivated one or more times for performing additional steps in the manufacturing process like attaching electronic modules, a second flexible substrate or attaching additional items to the intelligent device.

The use of a heat-activated adhesive for manufacturing intelligent devices allows for the possibility to stream-line production, makes the devices more reliable and increases the design possibilities.

An intelligent device on a flexible substrate can thus have the printed electronic devices, like conductive traces, antennas, etc stabilized by the adhesive film, which makes the function of the device more reliable and increases the potential use of such devices.

### DETAILED DESCRIPTION OF THE INVENTION

An anisotropic electrically conductive adhesive is an adhesive that has different electric conductivity in different directions; preferably it is conductive only through the adhesive film (z-direction) and insulating or having high impedance in the xy-plane. Conductive adhesives are typically a mix between an adhesive matrix and a conductivity agent.

In sufficient quantities (above the so-called percolation threshold) the conductive agents are in physical contact with one another, creating conductive pathways through the insulating adhesive matrix. Such conductive pathways have no specific direction and are thus called isotropic. If the quantity of conductive agents is lower than the percolation threshold no conductivity is possible for a bulk material. If, however, one of the dimensions (say the z-direction or the film thickness) of the said mix of materials (thermoplastic adhesive and conductive agent) is thin enough, the adhesive becomes conductive in the thin, z-direction. Thin enough means smaller or equal to the maximum thickness of the conductive agents in the adhesive mix. In this case the electric current will flow only in the z-direction, through the material, hence an anisotropic electrically conductive adhesive. In the xy-plane the concentration of conductive particles are too small to allow electric conductivity. Hence the material is insulating in the xy-plane. The diameter of the conductive particles will decide two properties of the adhesive. Firstly the maximum thickness of the adhesive film, secondly the minimum distance between two neighboring interconnections of the articles being permanently connected by the adhesive.

The percolation threshold depends on the shape of the particles, but it is often just below 20% of the total volume. This concentration is high enough to disturb the adhesion properties, so lower concentrations are often a criteria. For the anisotropic materials the typical concentration of conductive particles are somewhere between 0.5 and 18% depending on the end use, choice of materials and desired properties.

Today the conductive agents in most anisotropic conductive adhesives are carbon black, metal particles or metal coated particles. The adhesives with metal (rigid/hard) particles have good electrical conductivity but are associated with some important drawbacks. If using a hard particle that is not deformable or permissive the size of the particles becomes important. The diameter of the particles must not exceed the thickness of the adhesive film, if the adhesion is to be kept unaffected. If the particles are too large, they will influence the contact area since the particles will build up a distance between the substrate and the adhesive. For PSAs large particles will also induce built in tensions in the interface, leading to poor long term stability of the adhesion. If the particles are too small, they will only affect the strength of the adhesive, without any contribution to the conductivity. This discussion implies that the distribution of the particle diameter (the polydispersity) has to be as low as possible, and as close to the thickness of the adhesive film as possible.

In prior art adhesives with anisotropic electrically conductive properties are composed by a thermoplastic, acting against embrittlement, and a permanent crosslinking component (epoxies or radical polymerization). If using a crosslinking process for the curing, the adhesive may only be activated one time. Also, the adhesive tend to be brittle. This is normally not an issue since most anisotropically conductive adhesives find their use in LCD-display and other rigid (stiff) applications. A thermoplastic heat-sealable binder such as EAA or EVA is a compromise between extremely good adhesion on the one side and elasticity, flexibility and re-activation properties one the other. Heat-activated thermoplastic adhesives are adhesives that do not cure; they simply re-conform under applied heat and pressure, so that the substrate is wetted sufficiently. When heated sufficiently, the polymer melts, swells and wets the substrates. When it cools it hardens and shrinks again. This process can be repeated for a desired number of times without degrading the adhesion properties of the adhesive. Also the conductive properties will be preserved since there will be no phase separation when the adhesive activates.

The flexibility and elasticity of the thermoplastic binder assures good compatibility to flexible substrates having different modulus of elasticity. If two adhered materials with different modulus of elasticity are being bent or flexed, stress will be induced and concentrated to the joint. If the adhesive joint is brittle, it will break. If the adhesive joint is flexible it will even out the tension. This is a particularly important feature when the adhesion involves electric interconnections, where short glitches in the electric interconnections can have severe impact on the function of the intelligent package.

In accordance with the present invention a heat-activated adhesive can be used for mechanical adhering of a flexible material (lamination of paperboard); adhering of additional parts (medical) blisters, covering lids, displays and sensors); stabilization of printed conductive devices (traces, antennas and other); interconnection between conductive devices printed on different surfaces facing each other; adhering and electronically interconnection between (external) electronic modules and the printed conductive traces on the flexible material; sub-assembling of electronic components, such as batteries, buzzers, PCBs etc. to plastic films; qualification of sealing processes; tampering detection, activation of intelligent devices and activation of electronic modules.

The heat-activated adhesive is an adhesive formulation which is a mix between a thermoplastic elastic adhesive and a conductive agent.

The adhesive is applied in step 1. Then it is dried (the solvent (water, organic) is removed) in step 2. The activation is done in a last separate step 3. This feature clearly shows the versatility of the adhesive from a production perspective. E.g. it is possible to apply the adhesive to a flexible substrate in one location. For example one can print the adhesive on paperboard, before conversion to a package, in the first location. Then the sheets are sent to electronics specialists for mounting of the electric parts, after which the package is sent to a third station where a medical blister or a sensor, is applied. The short production scheme is an attempt to visualize that the adhesive makes it possible to make use of the competence of different producers. This also shows the importance of the re-activation feature of the adhesive.

Off-course it is possible to do all steps in one location; i.e. printing, conversion, mounting of electric parts and application of medical blisters etc. The point is that the adhesive makes the choice possible.

A heat activated adhesive can be chosen from a variety of available formulations. These formulations include water-based thermoplastics, organic solvent-based thermoplastics or a monomer formulation ready to be polymerized. The thermoplastic polymers are often possible to activate more than once, whilst for the monomer formulations the polymerization is irreversible, with a permanent tack.

A conductive agent is carbon black, intrinsically conductive polymers, metal particles or metal coated particles.

The function of the adhesive is to hold the different materials (electronic module, paperboard etc.) in the device together as an integrated part and to stabilize printed conductive devices (such as traces, antennas etc.). For the first function the adhesive must posses a sufficient adhesion to all materials within the device. For the second function it must be anisotropic to avoid interference between neighboring printed conductive traces. Also the elasticity is important when regarding the supporting of the printed devices. The elasticity requirement is crucial in this application, since the technique is based on flexible materials. Several studies have shown that creasing of a paperboard, having printed conductive traces, constitutes one of the most crucial points when fabricating the package. Without support the printed traces lose their conductivity after a few bendings. The main reason for loss in conductivity is microscopic cracks in the traces, originating from the stresses induced by the bendings that breaks the surface structure of the substrate. The best way to avoid such cracks is to apply a supportive layer of an elastic material over the traces. According to the invention an overprinting and a succeeding activation of a thermoplastic adhesive with elastic properties is a superior alternative to earlier known methods. It gives the same or better support, is easier to apply than the supportive tapes. Furthermore it can be used for other application in the device (mounting of electronic devices etc.). A printable thermoplastic is possible to apply over a large area in a single step.

An additional feature from the discussion above is that the adhesive may work as an electric interconnection between printed conductive traces printed on two surfaces facing each other.

The anisotropic conductive adhesive is tailored for mechanical stabilization of intelligent paperboard packages with printed conductive traces. The adhesive creates a strong joint for laminating or planar-pressing of disposable materials, such as paperboard. The flexible and film-formed adhesive also constitutes a flexible support for the creased or flexed materials, making the package foldable without harming the printed traces. Tests have shown that conductive traces extending over a creased line are many times more resistant to bendings (openings and closings of a package) if they are stabilized with the anisotropic adhesive compared to the unstabilized ones.

It is a well-known fact that laminating two paperboards will increase the rigidity and dimensional stability of the laminate, compared to single paperboard sheets.

When printing conductive traces on a flexible substrate, the trace width is often larger than necessary. The reason for this is to minimize the risk of fatal fractures due to cracks in the surface of the substrate. The drawback of this is that a lesser number of traces can be printed on the same area, making the package unnecessary large. By the aid of an anisotropic conductive adhesive, traces can be lead to a trace on an opposing surface. Now traces can be printed on two opposing sides, still being able to contact from the electronic module. This of-course demands a dielectric layer being printed between the two sides

This principle can be further developed into creating multiple layers of printed traces, with printed dielectric material in between. Still all layers can be contacted from the bottom level, where the electronic module is mounted.

The anisotropic property makes it possible to use the adhesive as an electric interconnection between two printed traces. This feature may be used for fabrication of membrane keyboards or to condense the printed conductive trace area on the package. As is understood from this discussion the anisotropic property is crucial to avoid interference between two neighboring conductive traces.

The adhesive can be used for heat-sealing of electronic modules (such as PCBs with multiple electronic interconnects) to flexible substrates with printed conductive traces. The anisotropic conductive adhesive has a fine pitch that makes it possible to have a small distance between adjacent interconnections. (See FIG. 2).

Many kinds of sensors, such as bio-sensors based on enzymes that create an electric current when activated, can be screen-printed in a conventional process. Such printed sensors have normally printed traces for contacting to electrical modules. This feature makes this kind of sensors ideally to combine with the technique described in this document. The printed traces can be contacted with traces on the package using the same adhesive as described above, and using the same heat-activation process.

The adhesive can be applied to a flexible plastic film, such as polyester having a metallized pattern matching the electronic components. Using the adhesive to mount the components (battery, buzzer, PCB etc.) makes the use of soldering obsolete. Using a thermoplastic adhesive for this purpose also makes the joint flexible, so that it can be used in flexible applications.

Lamination of sheets poses a challenge in terms of quality control and control over lamination parameters, such as activation time, temperature and pressure, is fundamental for the final result. The key is to apply enough energy (heat) to properly activate the adhesive and allow it to create a durable bond. If the activation energy is too low (too short activation time, too low temperature and/or too low pressure), the bond strength will be insufficient. On the other hand, too high activation energy may destroy the properties of the adhesive as well as the substrate, which in turn may cause quality problems in the finalized product.

However, quality control of laminated sheets in terms of durability and process consistency is very difficult and there is no established process in the printing industry.

By application of a printed conductive trace, which is designed to bridge between two layers being laminated on a plurality of locations, the resulting resistance of the trace can be measured. Any inconsistencies in the printing, adhesive and lamination process will then cause a deviation in resistance. By comparing the measured resistance value with an expected value, failed sheets can be rejected and an automatic and non-invasive feedback loop for the printing- and lamination process can be implemented.

Sealing verification can be monitored passively by printing a trace like the one for built-in quality control. When the trace constitutes a closed circuit the sealing process has been done properly.

Electrically conductive sealing can also be used for tamper detection. If anyone breaks or tampers with the sealing, the resistance of the seal changes and this event can be recorded as a tamper event. This off-course requires the mounting and initiation of electronics in an earlier step.

The tape adhesives (PSAs) have a mayor drawback when regarding the application of the tapes. The application involves removal of a release liner and adjustment of the film to the right place. The PSAs are also tacky, making them sensitive to dust and environmental impurities that decrease the tack of the adhesive.

The heat-sealable thermoplastic adhesive is non-tacky and can be applied using any conventional printing or spraying method.

The adhesive can now be applied in wet state on any desired substrate, preferably paperboard (coated or uncoated) or release liner, using any conventional printing method, preferably by screen-printing, rod-application or spraying. By choosing the proper mesh size of the screen-printing cloth, “any” thickness desired can be accomplished. After printing the adhesive is air-dried under controlled humidity to avoid deformation of the substrate.

It is preferred that the conductive traces have been printed before printing of the adhesive. After drying the adhesive can be activated at any time. A normal process involves a heat-sealing procedure (first activation) between two adhesive-coated paperboards or between an adhesive-coated and a paperboard without adhesive. After this the adhesive could be activated again (second step) when mounting any additional part (electronic module, electronic assembly, blister or lid). Such multiple activation processes clearly makes the re-activation property useful.

The adhesive can be applied (printed or bar coated) on a conventional release liner. After drying and activation a free standing anisotropic electrically conductive adhesive film is received. This film can be transferred to any suitable substrate in a later production step. The adhesive film is non-tacky, so it does not work as a tape. It has the same conductivity and activation properties as the substrate-printed adhesive, with the exception that it may be transferred.

### BRIEF DESCRIPTION OF THE DRAWINGS

FIG. 1 shows an intelligent device with printed conductive traces with crossing paths.

FIG. 2 shows a paperboard with printed conductive traces that has been coated with the anisotropicallt conductive adhesive. An electronical module (printed circuit board) is ready to be mounted onto the paperboard.

FIG. 3 shows a paperboard sheet before being laminated into a blister holding package.

FIG. 4 shows assembly of electronic components on a plastic film.

FIG. 5 shows a plastic film coated with the anisotropic adhesive, used to connect a battery.

FIG. 6 shows fabrication of a pattern for sealing qualification and tampering detection.

FIG. 7 shows a creased paperboard with printed conductive traces.

FIG. 8 shows a creased paperboard with printed conductive traces, with additional supportive traces on the opposing side of the paperboard.

### DETAILED DESCRIPTION OF THE PREFERRED EMBODIMENTS

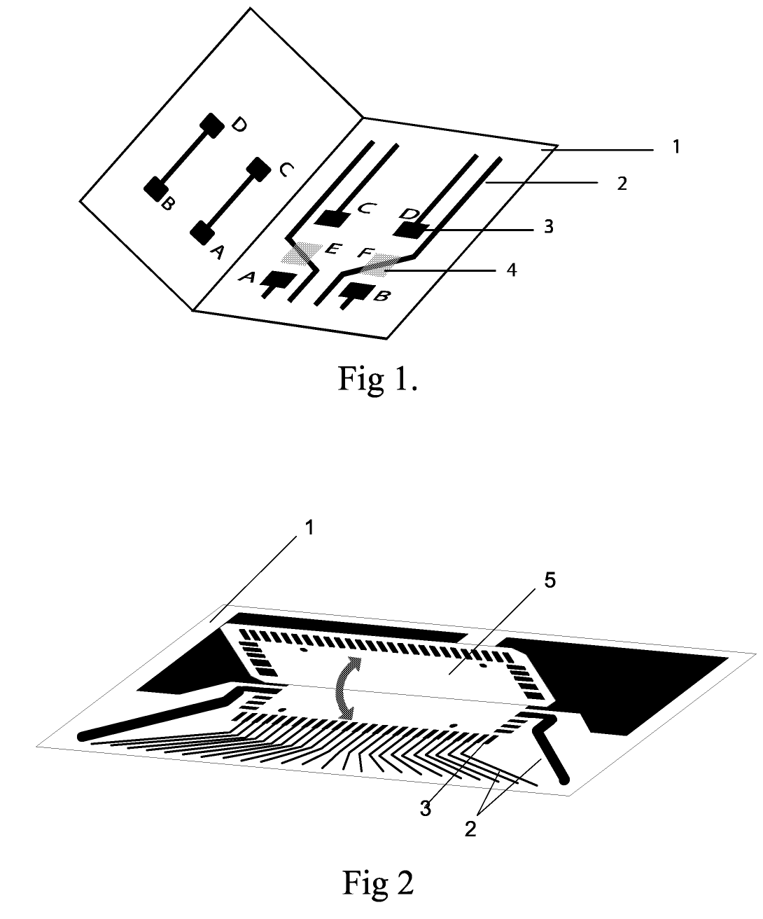

FIG. 1 shows a paperboard (1) with printed conductive traces (2), separated with a dielectric (4) in E and F. The connection points (3) A, B, C and D are connected via the anisotropic adhesive.

FIG. 2 shows mounting of an electronic module (5) on a flexible paperboard substrate (1). Electrical interconnections (3) and other printed electronic traces (2) are assured and interference avoided due to the anisotropic adhesive. The electronic module is aligned to the matching pad-pattern on the package.

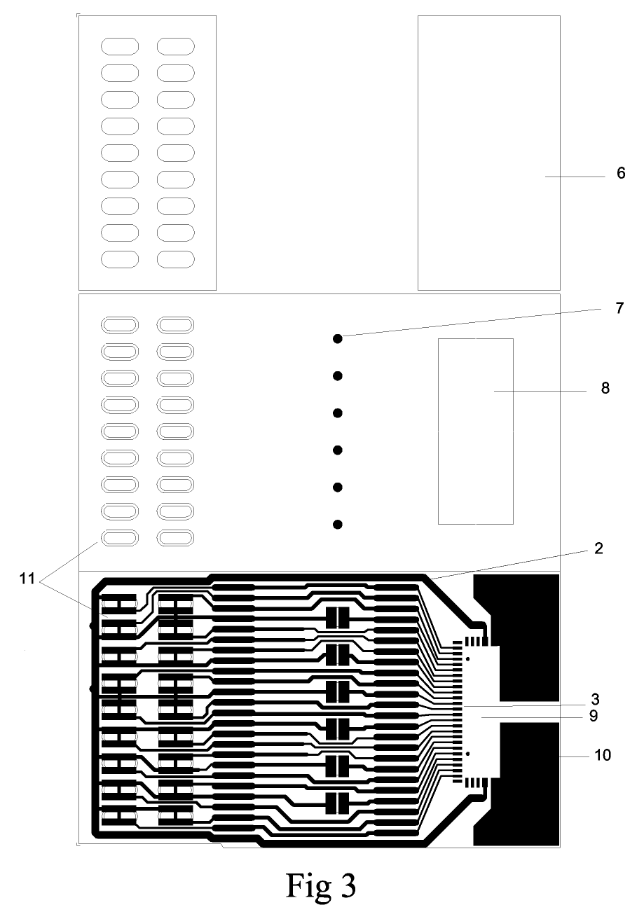

FIG. 3 shows a single-side-coated paperboard sheet printed on the uncoated side with a conductive carbon black ink in a pattern comprising conductive traces (2), antenna (10), pads for interconnection to an electronic module (3) and buttons (7).

The paperboard package comprises a covering lid (6) for an electronic module, openings (8) for the electronic module and an area (9) reserved for the attachment of the electronic module and an area (11) reserved for attachment of blister.

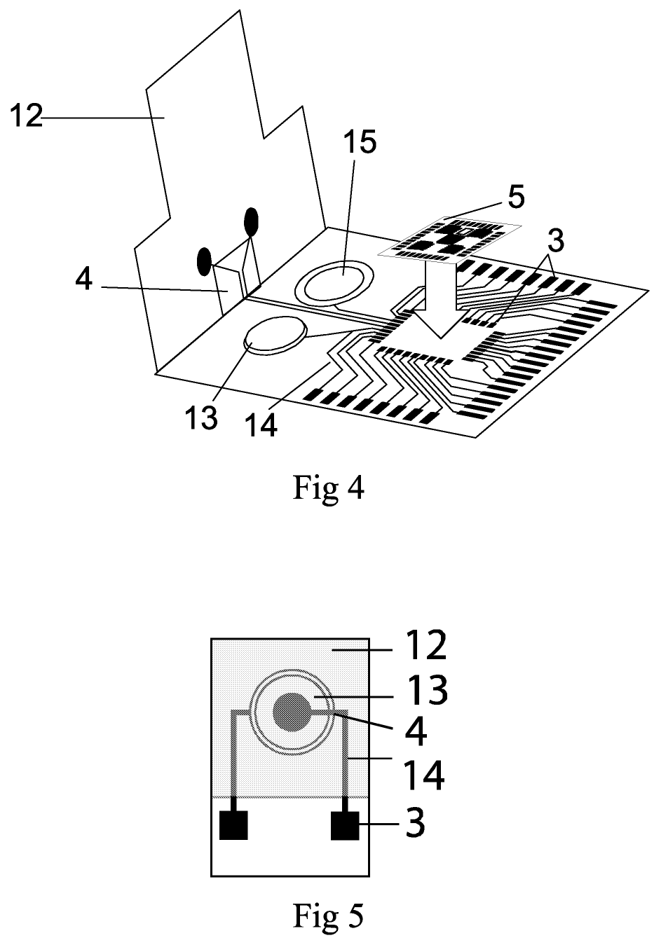

FIG. 4 shows assembly of electronic components on a plastic film (12). The film (12) has metal traces (14) in a specific pattern to conduct electric signals between an electronic module (5) and a battery (13) and a buzzer (15) placed at respective reserved areas (13, 15). Communication to external devices is accomplished via electrical connections (3) when the assembly is sealed to the external devices. The polyester film (12) is folded; see FIG. 5 and the back of the battery is sealed so that the battery is enclosed in the film.

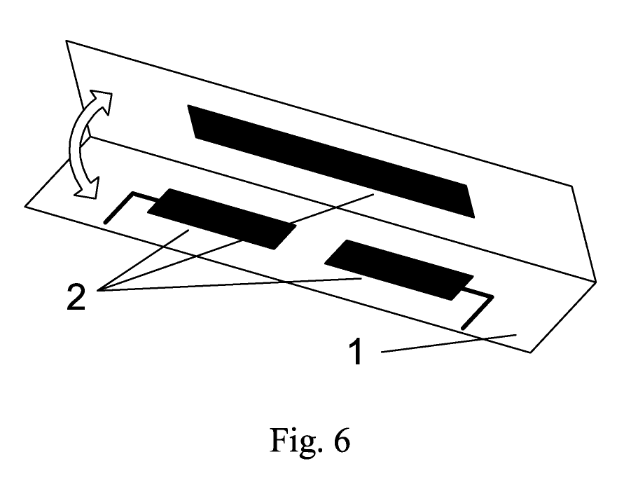

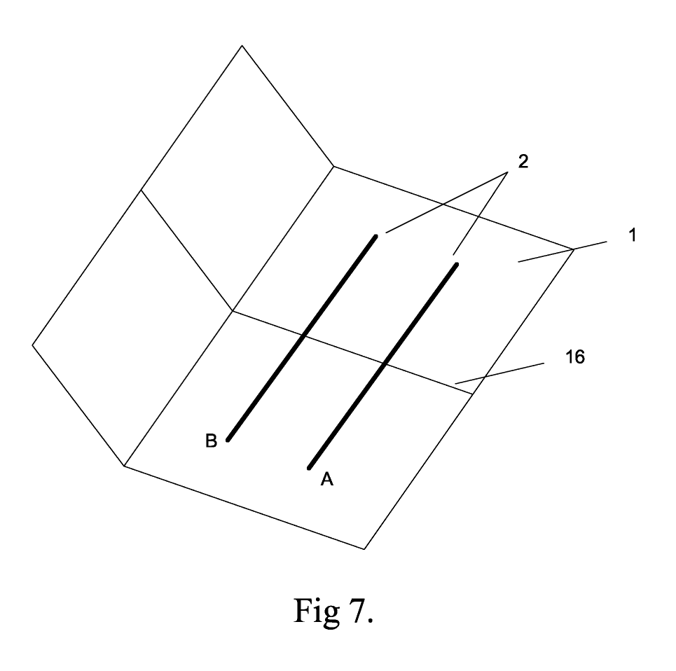

FIG. 6 shows a pattern of printed conductive traces (2) on a paperboard substrate (1), which can be folded together. The pattern is designed for sealing qualification and tamper detection. If the sealing procedure is made in a proper way, the electronic interconnection between the conductive traces will be below a specified resistance. When the resistance is measured after the fold has been sealed, a too high resistance indicates a failure of the sealing. Likewise will later on a tamper event result in a change of resistance which can be measured.

FIG. 7 shows a not-yet laminated board (1) with conductive traces (2) and a creasing line (16). The adhesive is printed over paperboard which is subsequently laminated and creased.

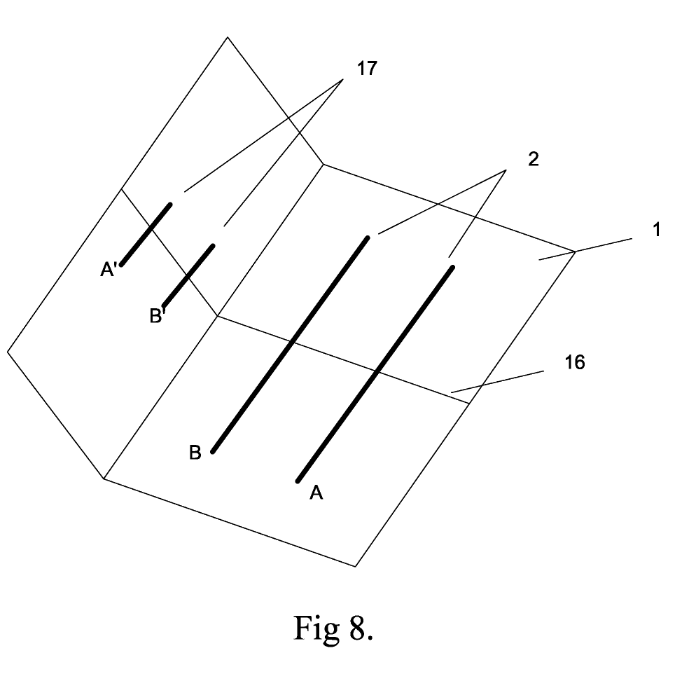

FIG. 8 shows a not-yet laminated board (1) having a support structure of extra printed conductive traces (17). Printed trace A′ supports trace A and B′ supports trace B.

### EXAMPLE 1

### Step 1

A water-based thermoplastic Ethylene Acrylic Acid (EAA) emulsion (35% dry weight) (Trade name: MichemPrime 4983 RHSA) is mixed with 3% (based on the dry weight) carbon black of electrical grade and mixed to homogeneity. The viscosity of the mixture is increased by adding 2% (based on wet weight) of an alkali swell able emulsion, ASE (trade name: Viscalex HV30).

### Step 2

The formulated adhesive is screen printed on the uncoated side of the paperboard. The whole surface is covered, with exception for the printed buttons. A 60 mesh silk screen is used. After air-drying in controlled humidity the paperboard is embossed and die-cut. Before heat activation of the adhesive additional lids are removed so that the area where the electronic module is to be mounted remains open. These areas are covered with liners to avoid undesired adhesion during the activation. The activation temperature is 120 C for 20 seconds. After cooling the laminate is creased according to material specifications given by the paperboard supplier.

### Step 3

When the package (creased laminate) has been fabricated the electronic module (a PCB made of FR4) can be mounted. The electronic module is aligned to the matching pad-pattern on the package. A metal stamp heated to 120 C, designed in such way that it presses only on the interconnection area of the electronic module, not on the paperboard and not on the electronic components on the module is pressed down for 20 seconds. Finally an additional covering lid, printed with the same adhesive, is placed over the electronic module and heat pressed using the same parameters.

### Step 4

Now the additional (passive) parts are mounted. A medical blister can be put in place and a covering lid printed with the formulated adhesive is heat-sealed at 120 C for 20 seconds to hold the blister on place permanently.

### EXAMPLE 2

Mounting of an electrical component to a plastic film can be done following the below steps.

### Step 1

A water-based thermoplastic aliphatic polyurethane emulsion (45% dry weight) (Trade name: Kiwotherm D120) is mixed with 15% (based on the dry weight) silver coated nickel spheres and mixed to homogeneity.

FIG. 4 shows that a polyester (Poly EthyleneNaphthalate, PEN) film (1) with a metallized pattern (14) of gold coated copper is coated with a dielectric on selected areas (12) to avoid short-circuitry.

Step 2

The polyester film is bar-coated with the adhesive to a resulting thickness of 15 μm after drying.

### Step 3

A battery is placed on the battery pad (13) on the polyester film (1) and a stamp activates the adhesive and seals the battery at a temperature of 120 C for 5 seconds. The polyester film (21) is folded and the back of the battery is sealed the same way so that the battery is enclosed in the film, see FIG. 5.

### EXAMPLE 3

Fabrication of an electrical assembly

### Step 1

A water-based thermoplastic aliphatic polyurethane emulsion (45% dry weight) (Trade name: Kiwotherm D120) is mixed with 15% (based on the dry weight) silver coated nickel spheres and mixed to homogeneity.

A polyester (Poly EthyleneNaphthalate, PEN) film with a metallized pattern of gold coated copper (see FIG. 4) is coated with a dielectric on selected areas to avoid short-circuitry.

### Step 2

The polyester film is bar-coated with the adhesive to a resulting thickness of 15 μm after drying.

### Step 3

A battery is placed on the battery pad on the polyester film and a stamp activates the adhesive and seals the battery at a temperature of 140 C for 2 seconds. The polyester film is folded and the back of the battery is sealed the same way so that the battery is enclosed in the film.

A piezo-element (buzzer) is placed on the buzzer pad on the polyester film and a stamp activates the adhesive and seals the buzzer at a temperature of 140 C for 2 seconds. The polyester film is folded and the back of the buzzer is sealed the same way so that the buzzer is enclosed in the film.

The electronic module (a PCB made of FR4) is aligned to the matching pad-pattern on the polyester film. A stamp activates the adhesive and seals the electronic module at a temperature of 140 C for 2 seconds.

### Step 4

The polyester film with assembled electronic is aligned to a printed paperboard package (like the one in preferred embodiment) so that the interconnections on the polyester film matches the ones on the paperboard. The two items are heat-sealed at 140 C for 2 seconds using a metal stamp.

### EXAMPLE 4

Utilization of the anisotropic adhesive for transfer of electric signals between traces on different surfaces.

### Step 1

A water-based thermoplastic Ethylene Vinyl Acetate (EVA) emulsion (45% dry weight) (Trade name: Adcote 37R972) is mixed with 1.5% (based on the dry weight) carbon black of electrical grade and mixed to homogeneity.

A single-side-coated paperboard sheet is printed on the uncoated side with a conductive carbon black ink in a pattern according to FIG. 1. A dielectric is printed over selected areas to avoid undesired interference between conductive traces.

### Step 2

The formulated adhesive is screen printed on the uncoated side of the paperboard. The whole surface is covered. A 60 mesh silk screen is used. After the printing the paperboard is air-dried at controlled humidity. When dried the paperboard can be folded and heat-sealed at any time. The activation is performed at 80 C for 30 seconds in a heat-sealer. Now a trace can start in one point, go via the anisotropic conductive adhesive in point A and B to the facing surface and travel over other printed traces (if they are covered with a dielectric in point E and F). Finally the traces can be lead down to the original surface again in point C and D.

### Step 3

An electronic module is attached to the traces so that current can go through the printed traces and events can be recorded.

### EXAMPLE 5

Fabrication of film-formed adhesive.

The adhesive in preferred embodiment, example 1 or example 2 is printed on a release liner, air-dried and activated (film-formed) in a laminator at 120 C so that a free-standing film is accomplished. Using this concept the adhesive does not have to be printed directly on the substrate, it can be formulated anywhere in a separate process and then be transferred for example to the production of the items described in preferred embodiment and example 1 and 2. It has the same conduction and activation properties as the substrate printed adhesive, with the exception that it may be incorporated into any process without involving wet application.

### EXAMPLE 6

Attachment of a sensor to a device using the anisotropic adhesive.

A printed sensor for detection of special molecules, with printed conductive traces, can be aligned and attached to printed conductive traces on the package in preferred embodiment using the adhesive as interconnection. This way the package can interact with bio-sensitive devices.

### EXAMPLE 7

The pattern in example 2 is changed to the pattern in FIG. 6. This way it is possible to detect whether a circuit is opened or closed. This feature can be used for both tampering detection and for built-in sealing control. In the first case tempering is detected when the circuit is opened. In the second case the sealing is monitored when the circuit is closed.

Built-In Sealing Control

If printing a pattern like the one found in FIG. 6, with the printed traces going to a contact interface for electronic monitoring of the resistance of the traces, the sealing process can be controlled without destroying the sample. When heat-sealing the paperboard substrate with the anisotropic conductive adhesive a circuit is made. If the sealing has been properly performed, the resistance of the circuit will be kept within a specified range. If not, the sealing has been insufficient (the contact is not good because the pressing time has been too short for activation of the adhesive, hence the electric interconnection is insufficient.

Tampering Detection

To monitor whether a package has been opened or has been tampered with traces can be printed over selected areas. When a trace is broken the electronics monitors the event. A trace is broken when the resistance increases. The resistance increases when the two substrates are separated, breaking the circuit.

### EXAMPLE 8

Fabrication of support for conductive traces over creasings.

A water-based thermoplastic Ethylene Acrylic Acid (EAA) emulsion (35% dry weight) (Trade name: MichemPrime 4983 RHSA) is mixed with 3% (based on the dry weight) carbon black of electrical grade and mixed to homogeneity.

A single-side-coated paperboard sheet (Invercote G) is printed on the uncoated side with a conductive carbon black ink in a pattern comprising conductive traces according to FIG. 7

The formulated adhesive is screen printed on the uncoated side of the paperboard. The whole surface is covered. A 100 mesh silk screen is used. Finally the adhesive is air-dried.

A second single-side-coated paperboard sheet without printed conductive traces is coated likewise with the adhesive.

The two paperboard sheets are laminated together at 110 C for 12 seconds. After the heat-activation of the adhesive the laminate is creased over the double conductive traces.

### EXAMPLE 9

Fabrication of extra-strength support for conductive traces over creasings.

A water-based thermoplastic Ethylene Acrylic Acid (EAA) emulsion (35% dry weight) (Trade name: MichemPrime 4983 RHSA) is mixed with 3% (based on the dry weight) carbon black of electrical grade and mixed to homogeneity. The viscosity of the mixture is increased by adding 2% (based on wet weight) of an alkali swell able emulsion, ASE (trade name: Viscalex HV30).

A single-side-coated paperboard sheet (Invercote G) is printed on the uncoated side with a conductive carbon black ink in a pattern comprising conductive traces according to FIG. 8.

The formulated adhesive is screen printed on the uncoated side of the paperboard. The whole surface is covered. A 60 mesh silk screen is used. Finally the adhesive is air-dried.

A second single-side-coated paperboard sheet having matching printed conductive traces of the same ink (see FIG. 8) is laminated to the first paperboard at 120 C for 10 seconds. After the heat-activation of the adhesive the laminate is creased over the double conductive traces.

### EXAMPLE 10

Activation of an intelligent device

Using a printed pattern, like the one found in FIG. 6 it is possible to measure if a circuit is open or close. This feature can be used to activate the functionality of an intelligent device. When the circuit is closed, the device registers this and activates the functions in the devise, for instance intrusion and tamper detecting features. This way the sealing procedure is verified and the device is activated without external interaction.

1. Use of a heat-activated adhesive for manufacturing of intelligent devices comprising an electronic module and printed conductive electronics, like conductive traces, antennas on a flexible substrate, characterized by that the adhesive is an anisotropic electrically conductive thermoplastic adhesive and is applied to the substrate as a thin film which can be used for adhering components to the substrate, for electrical connections and for providing mechanical stability to the printed conductive traces.

2. Use of a heat-activated adhesive in accordance with claim 1 characterized by that the adhesive comprises an adhesive part and a conductive component.

3. Use of a heat-activated adhesive in accordance with claim 2, characterized by that the adhesive part comprises a solvent- or water based thermoplastic emulsion, having an activation temperature in the interval 80 to 130 C.

4. Use of a heat-activated adhesive in accordance with claim 2, characterized by that the conductive part of the adhesive comprises homogeneously distributed Intrinsically Conductive Polymers, ICPs, of a concentration based on dry weight of 1-20%.

5. Use of a heat-activated adhesive in accordance with claim 2, characterized by that the conductive part of the adhesive comprises homogeneously distributed carbon black particles, of a concentration based on dry weight of 1-20%.

6. Use of a heat-activated adhesive in accordance with claim 2, characterized by that the conductive part of the adhesive comprises homogeneously distributed metal or metal coated particles, of a concentration based on dry weight of 1-20%.

7. Use of a heat-activated adhesive in accordance with claim 1, characterized by that the adhesive is applied to the substrate by a printing method, such as for example screen printing, offset printing, ink jet printing, flexo printing, spraying or bar-coating.

8. Use of a heat-activated adhesive in accordance with claim 1, characterized by that the adhesive film is used for attaching additional parts to the device, such as for example blisters, covering lids, displays, sensors, batteries, buzzers, circuit boards, electronic chips to the device.

9. Use of a heat-activated adhesive in accordance with claim 1, characterized by that the substrate comprises a material such as paper, paperboard, fiber glass, metal, plastics or combinations thereof.

10. Use of a heat-activated adhesive in accordance with claim 9, characterized by that the substrate comprises a release liner, and that the heat-activated adhesive after being printed is dried and formed into a non-tacky free-standing film.

11. Use of a heat-activated adhesive in accordance with claim 1, characterized by that the adhesive film is used for adhering a second flexible substrate to the first substrate.

12. Use of a heat-activated adhesive in accordance with claim 11, characterized by that the second flexible substrate comprises conductive traces and that the adhesive film allows electric contact between the conductive traces on the second flexible substrate and the conductive traces on the first substrate.

13. Use of a heat-activated adhesive in accordance with claim 12, characterized by the intelligent device comprises multiple flexible layers of substrates comprising printed traces on each layer separated by a printed dielectric material and that the printed traces on all layers can be contacted from the first substrate, where an electronic module is mounted.

14. Use of a heat-activated adhesive in accordance with claim 1, characterized by that the adhesive is activated by IR-reflow, heat roll lamination, heated planar press or the like.

15. An intelligent device manufactured by using a heat-activated adhesive in accordance with claim 1.

16. An intelligent device manufactured in accordance with claim 15, characterized by that a resistance between the first and second substrates can be measured in order to determine a quality of the adherence between the substrates.

17. An intelligent device in accordance with claim 16, characterized by that the quality of the adherence is used for detecting tampering with the device.

18. Use of a heat-activated adhesive in accordance with claim 3, characterized by that the conductive part of the adhesive comprises homogeneously distributed Intrinsically Conductive Polymers, ICPs, of a concentration based on dry weight of 1-20%.

19. Use of a heat-activated adhesive in accordance with claim 3, characterized by that the conductive part of the adhesive comprises homogeneously distributed carbon black particles, of a concentration based on dry weight of 1-20%.

20. Use of a heat-activated adhesive in accordance with claim 3, characterized by that the conductive part of the adhesive comprises homogeneously distributed metal or metal coated particles, of a concentration based on dry weight of 1-20%.
